(19) United States
(12) Patent Application Publication
(10) Pub. No.: US 2024/0357389 A1
(43) Pub. Date: Oct. 24, 2024

(54) USER DATA RATE ESTIMATION DEVICE, USER DATA RATE ESTIMATION METHOD, AND PROGRAM

(71) Applicant: NIPPON TELEGRAPH AND TELEPHONE CORPORATION, Tokyo (JP)

(72) Inventors: Masashi IWABUCHI, Musashino-shi, Tokyo (JP); Tomoaki OGAWA, Musashino-shi, Tokyo (JP); Hiroki YOSHIOKA, Musashino-shi, Tokyo (JP); Masayoshi NABESHIMA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/685,516

(22) PCT Filed: Aug. 27, 2021
(86) PCT No.: PCT/JP2021/031601

§ 371 Date: Feb. 22, 2024

(51) Int. Cl. H04W 24/08; H04B 17/318

(52) U.S. Cl. CPC H04W 24/08; H04B 17/318

(57) ABSTRACT

A user data rate estimation device acquires a reception power in a user, and receives input of information regarding a communication environment of the user. Next, the device calculates a wireless resource to be allocated to the user on the basis of information regarding a bandwidth, a scheduling method, and the number of users included in the information regarding the communication environment, calculates an overhead on the basis of information regarding a communication standard, a frequency band, and a bandwidth included in the information regarding the communication environment, and determines a communication mode on the basis of the reception power or communication quality information converted from the reception power. Then, the device calculates a user data rate on the basis of the wireless resource, the overhead, the communication mode, and information regarding the number of spatial streams included in the information regarding the communication environment.

### TECHNICAL FIELD

The present disclosure relates to a user data rate estimation device, a user data rate estimation method, and a program.

### BACKGROUND ART

Nowadays, a cellular system and a wireless LAN system are sophisticated and used in various scenarios. When these wireless communication systems are applied, there is an increasing need to ascertain an indication of a data rate that can be achieved in advance in order to determine which system is be deployed and how to deploy the system. Also in the case of operating a wireless communication system that is already constructed, there is a need to manage wireless communication quality including a data rate in addition to a reception power.

A conventional data rate calculation method is disclosed in Non Patent Literature 1 and Non Patent Literature 2. In a conventional method, a maximum data rate that can be achieved by a user by inputting a parameter of a wireless communication system is calculated. There is also a tool for calculating a data rate by using computer simulation.

### CITATION LIST

### Non Patent Literature

Non Patent Literature 1: 3GPP TS 38.101-1 version 15.3.0 Release15, “5G;NR; User Equipment (UE) radio transmission and reception; Part 1: Range 1 Standalone” Non Patent Literature 2: 3GPP TS 38.101-2 version 15.5.0 Release 15, “5G; NR; User Equipment (UE) radio transmission and reception; Part 2: Range 2 Standalone”

However, in the conventional methods disclosed in Non Patent Literature 1 and Non Patent Literature 2, only the maximum data rate can be calculated, and a user data rate in various communication environments cannot be calculated. In computer simulation, there is a problem that it takes time to obtain a result through calculation.

### SUMMARY OF INVENTION

### Technical Problem

The present disclosure has been made in view of the above circumstances, and an object thereof is to provide a technique capable of easily estimating a user data rate according to a communication environment of a user.

### Solution to Problem

In order to achieve the above object, the present disclosure provides a user data rate estimation device. The user data rate estimation device of the present disclosure is configured to execute the following processing. A first process is to acquire a reception power in a user. A second process is to receive input of information regarding a communication environment of the user. A third process is to calculate a wireless resource to be allocated to the user on the basis of information regarding a bandwidth, a scheduling method, and the number of users included in the information regarding the communication environment. A fourth process is to calculate an overhead on the basis of information regarding a communication standard, a frequency band, and a bandwidth included in the information regarding the communication environment. A fifth process is to determine a communication mode on the basis of the reception power or communication quality information converted from the reception power. A sixth process is to calculate a user data rate on the basis of the wireless resource, the overhead, the communication mode, and information regarding the number of spatial streams included in the information regarding the communication environment.

The present disclosure provides a user data rate estimation method in order to achieve the above object. The user data rate estimation method of the present disclosure includes the following steps. A first step is to acquire a reception power in a user. A second step is to receive input of information regarding a communication environment of the user. A third step is to calculate a wireless resource to be allocated to the user on the basis of information regarding a bandwidth, a scheduling method, and the number of users included in the information regarding the communication environment. A fourth step is to calculate an overhead on the basis of information regarding a communication standard, a frequency band, and a bandwidth included in the information regarding the communication environment. A fifth step is to determine a communication mode on the basis of the reception power or communication quality information converted from the reception power. A sixth step is to calculate a user data rate on the basis of the wireless resource, the overhead, the communication mode, and information regarding the number of spatial streams included in the information regarding the communication environment.

Furthermore, the present disclosure provides a program in order to achieve the above object. A program of the present disclosure includes a program for causing a computer to execute the user data rate estimation method. The user data rate estimation device can be realized by the computer and the program of the present disclosure. The program of the present disclosure may be recorded in a computer-readable recording medium or may be provided via a network.

### Advantageous Effects of Invention

According to the technique of the present disclosure, it is possible to easily estimate a user data rate according to a communication environment of a user.

### BRIEF DESCRIPTION OF DRAWINGS

FIG. 1 is a diagram illustrating a configuration of a user data rate estimation device according to a first embodiment of the present disclosure.

FIG. 2 is a diagram illustrating a configuration of a data rate estimation unit of the user data rate estimation device.

FIG. 3 is a diagram illustrating a correspondence relationship between a parameter used to calculate a user data rate and each function of the user data rate estimation device.

FIG. 4 is a table illustrating an input/output relationship of a parameter used to calculate a user data rate in the user data rate estimation device.

FIG. 5 is a diagram illustrating a first acquisition pattern for a reception power used to calculate a user data rate.

FIG. 6 is a diagram illustrating a second acquisition pattern for a reception power used to calculate a user data rate.

FIG. 7 is a diagram illustrating a third acquisition pattern for a reception power used to calculate a user data rate.

FIG. 8 is a diagram illustrating a configuration of a user data rate estimation device according to a second embodiment of the present disclosure.

FIG. 9 is a diagram illustrating an example of a hardware configuration applicable to the user data rate estimation device.

### Description of Embodiments

Hereinafter, embodiments of a user data rate estimation device, a user data rate estimation method, and a program according to the present disclosure will be described with reference to the drawings. However, the following embodiments can be variously modified and implemented without departing from the concept of the present disclosure. That is, in the embodiments described below, in a case where a number such as the number, a volume, an amount, or a range of each element is mentioned, the technical idea according to the present disclosure is not limited to the mentioned number unless otherwise specified or clearly specified in principle. Structures and the like described in the embodiments described below are not necessarily essential to the technical idea according to the present disclosure, except for a case where the structures and the like are particularly specified or clearly specified in principle.

### 1. First Embodiment

### 1-1. Configuration and Function of User Data Rate Estimation Device

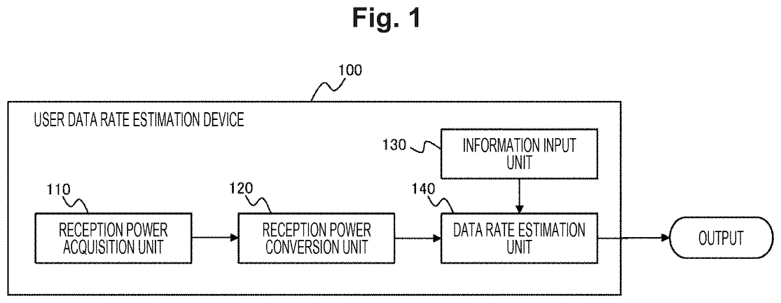

FIG. 1 illustrates a configuration of a user data rate estimation device according to a first embodiment. In the first embodiment, a user data rate estimation device 100 includes a reception power acquisition unit 110, a reception power conversion unit 120, an information input unit 130, and a data rate estimation unit 140. Hereinafter, functions of the units 110 to 140 configuring the user data rate estimation device 100 will be described.

The reception power acquisition unit 110 is configured to acquire a reception power in a user. The reception power to be acquired may be an actual measured value or a calculated value (estimation value) obtained through computer simulation. The reception power acquisition unit 110 outputs the acquired reception power to the reception power conversion unit 120.

The reception power conversion unit 120 is configured to convert reception power acquired in different bands into a reception power in a target band. For example, in a case where an acquisition method is measurement, the reception power in the target band may be calculated from a measured reception power by using the following conversion formula. However, in the following conversion formula, a measurement bandwidth in a band for which measurement is performed is expressed as measurement bandwidth @ measurement band, a measurement bandwidth in a target band is expressed as measurement bandwidth @ target band, and a reception power in the target band is expressed as reception power @ target band.

$$Reception power @ target band = measured reception power [ dBm ] +$$

$$transmission power difference [ dB ] +$$

$$transmission antenna gain difference [ dB ] +$$

$$reception antenna gain difference [ dB ] +$$

$$10 * {log}_{10} ( measurement bandwidth @ target band /$$

$$measurement bandwidth @ measurement band )$$

The reception power conversion unit 120 may obtain a cumulative probability by using a plurality of reception power values obtained by the reception power acquisition unit 110. For example, a reception power having a 50% value may be calculated and used for subsequent processes. The reception power conversion unit 120 outputs the reception power in the target band obtained through the conversion to the data rate estimation unit 140.

The information input unit 130 is configured to receive input of information other than the reception power necessary to calculate the data rate. The information received by the information input unit 130 includes information regarding a communication environment of a user. The information input unit 130 outputs the input information to the data rate estimation unit 140. Details of the information output from the information input unit 130 to the data rate estimation unit 140 will be described later.

The data rate estimation unit 140 is configured to estimate a user data rate by using the reception power input from the reception power conversion unit 120 and the information input from the information input unit 130. The user data rate estimated by the data rate estimation unit 140 is output from the user data rate estimation device 100. Details of a configuration and a function of the data rate estimation unit 140 will be described in the next section.

### 1-2. Configuration and Function of Data Rate Estimation Unit

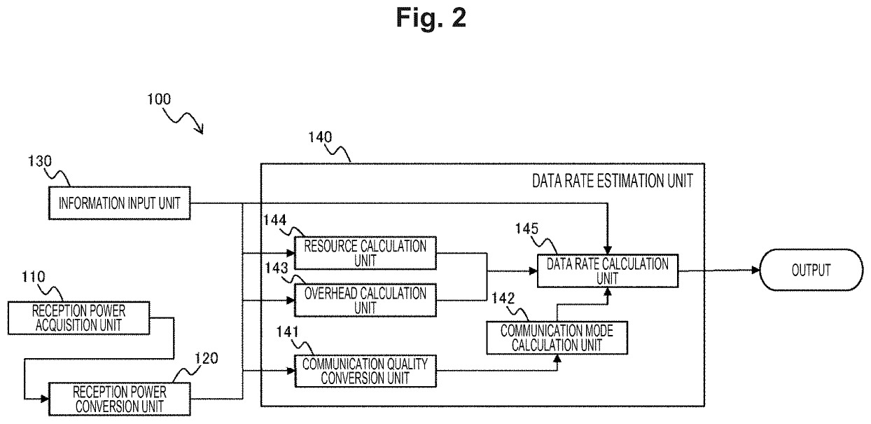

Next, details of a configuration and a function of the data rate estimation unit 140 will be described with reference to FIG. 2. The data rate estimation unit 140 includes a communication quality conversion unit 141, a communication mode calculation unit 142, an overhead calculation unit 143, a resource calculation unit 144, and a data rate calculation unit 145. Hereinafter, functions of the units 141 to 145 configuring the data rate estimation unit 140 will be described.

The communication quality conversion unit 141 is configured to convert the reception power input from the reception power conversion unit 120 into communication quality information. In the present embodiment, it is assumed that the reception power is converted into a signal-to-noise ratio (SNR) that is an example of communication quality information. When converting the reception power into an SNR, the communication quality conversion unit 141 uses a noise figure included in the information input in the information input unit 130. For conversion of the reception power into the SNR, for example, the following conversion formula may be used. The communication quality conversion unit 141 outputs the communication quality information (SNR) obtained according to the following conversion formula to the communication mode calculation unit 142. Here, k is the Boltzmann constant, T is an absolute temperature, and B is an equivalent noise bandwidth.

$$Noise power value = 10 * {log}_{10} ( k * T * B ) + 10 * {log}_{10} ( bandwidth used for measurement of reception power ) + noise figure \\ SNR = reception power value - noise power value \\ ( unit : dB )$$

The communication mode calculation unit 142 is configured to determine a communication mode by using the communication quality information input from the communication quality conversion unit 141. The communication mode is specifically represented by a modulation level and a coding rate. A correspondence table between communication quality information and a communication mode stored in advance is used to determine a communication mode. Note that the communication mode calculation unit 142 may also determine a communication mode by using the reception power input from the reception power conversion unit 120 instead of the communication quality information. In this case, a correspondence table between a reception power and a communication mode is used. The communication mode calculation unit 142 outputs the determined communication mode to the data rate calculation unit 145.

The overhead calculation unit 143 is configured to calculate an overhead by using information input to the information input unit 130. For the calculation of the overhead, information such as a communication standard, a frequency band, an up-down link direction, and a bandwidth included in the information input to the information input unit 130 is used. The “communication standard” refers to, for example, 5G, a wireless LAN (IEEE802.11n, IEEE802.11ac, IEEE802.11ax, or the like), or other wireless communication standards. The “frequency band” is a frequency band in which the system is operated, and for example, FR1 or FR2 in 5G corresponds thereto. The “up-down link direction” indicates whether a communication direction is an uplink or a downlink. The “bandwidth” is a frequency channel width. A correspondence table is prepared in the overhead calculation unit 143 in advance. The overhead calculation unit 143 inputs respective values of the communication standard, the frequency band, and the bandwidth to the correspondence table, and outputs an overhead value obtained from the correspondence table to the data rate calculation unit 145.

The resource calculation unit 144 is configured to calculate a wireless resource for each user by using the information input to the information input unit 130. For the calculation of a wireless resources, information such as a bandwidth, a scheduling method, and the number of users included in the information input to the information input unit 130 is used. The “bandwidth” is a frequency channel width. As the “scheduling method”, for example, norms such as round robin and proportional fairness are input. The resource calculation unit 144 calculates a time resource allocation rate for a user on the basis of the input norms. The “number of users” is the number of users assumed by an executor of an estimation process. The resource calculation unit 144 outputs a numerical value corresponding to the calculated wireless resource to the data rate calculation unit 145.

The data rate calculation unit 145 is configured to calculate a user data rate by using the information input to the information input unit 130 and calculation results input from the communication mode calculation unit 142, the overhead calculation unit 143, and the resource calculation unit 144. In the calculation of the user data rate, information such as the number of spatial streams and an uplink/downlink ratio included in the information input to the information input unit 130 is used. The “number of spatial streams” is the number of streams assumed by an executor of an estimation process in a case where MIMO transmission is performed. The “uplink/downlink ratio” is a time resource ratio between an uplink and a downlink in a case where a result in time division duplex (TDD) transmission is calculated.

The data rate calculation unit 145 calculates a user data rate by using the following Formula (1), for example. Formula (1) is a calculation formula in a case where it is assumed that the user data rate estimation device 100 according to the present embodiment is applied to a 5G cellular system. In a case where the user data rate estimation device 100 is applied to a 5G cellular system, a user data rate calculated by the data rate calculation unit 145 by using Formula (1) is output from the user data rate estimation device 100.

$$[ Math . 1 ]$$

$$rate = \qquad ( 1 )$$

$${10}^{- 6} \cdot {\sum }_{j = 1}^{J} ( {v}_{Layers}^{( j )} \cdot {f}^{( j )} \cdot ( 1 - γ ) \cdot {R}_{TDD} \cdot {Q}_{m}^{( j )} \cdot {R}_{m}^{( j )} \cdot \frac{{N}_{PRB}^{BW ( j ) , μ} \cdot 12}{{T}_{s}^{μ} {N}_{user}^{( j )}} \cdot ( 1 - {OH}^{( j )} ) )$$

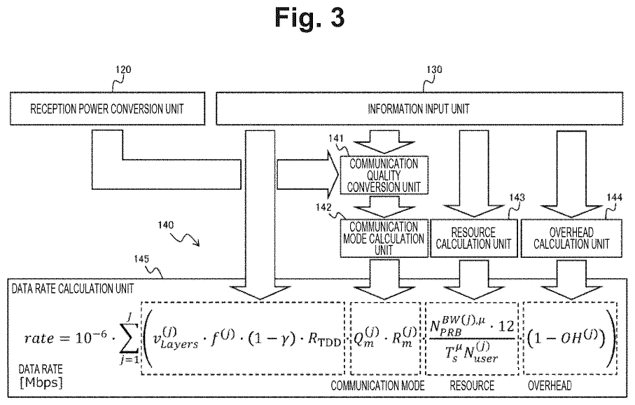

FIG. 3 illustrates which function of the data rate estimation unit 140 calculates the parameters of the above calculation Formula (1). Definitions of the parameters used to calculate the user data rate are shown in the following table.

TABLE 1

| PARAMETER | EXPLANATIONS |
|---|---|
| COMMUNI- | For example, 5G, Wi-Fi (IEEE802.11n, |
| CATION | IEEE802.11ac,IEEE802.11ax or the like) or |
| STANDARD | other wireless communication standards |
| FR | Parameter that indicates frequency band and is, for |
| | example, FR1 (4.5 GHZ) or FR2 (28 GHZ) in 5G |
| DUP | Selection of uplink and downlink as calculation target |
| J | Number of frequency channels |
| BW₍ⱼ₎ | Bandwidth per frequency channel (frequency channel |
| | bandwidth) |
| μ | Parameter that indicates numerology, specific to 5G, |
| | and used to derive OFDM subcarrier interval and |
| | symbol length. OFDM subcarrier interval = 15*2^{μ} kHZ |
| v_{Layers}^{(j)} | Number of spatial streams at frequency channel #j |
| f^{(j)} | Scaling factor at frequency channel #j. freely set in |
| | range from 0 to 1. |
| NF | Noise figure |
| γ | Block error rate |
| Nᵤₛₑᵣ | Number of assumed terminals |
| R_{TDD} | Ratio of designated link. for example, when |
| | uplink/downlink ratio is DL:UL = 9:1, 0.9 in case |
| | where downlink is designated, and 0.1 in case where |
| | uplink is designated. |
| P | Converted communication quality |
| Qₘ^{(j)} | Modulation level at frequency channel #j |
| Rₘ^{(j)} | Coding rate at frequency channel #j |
| N_{PRB}^{BW(j),μ} | Maximum number of allocated resource blocks |
| Tₛ^{μ} | Average of dm symbol length (Normal CP) * |
| | Calculated by using following formula |
| | ${T}_{s}^{μ} = \frac{{10}^{- 3}}{{14.2}^{μ}}$ |
| OH^{(j)} | Overhead |
| rate | User data rate |

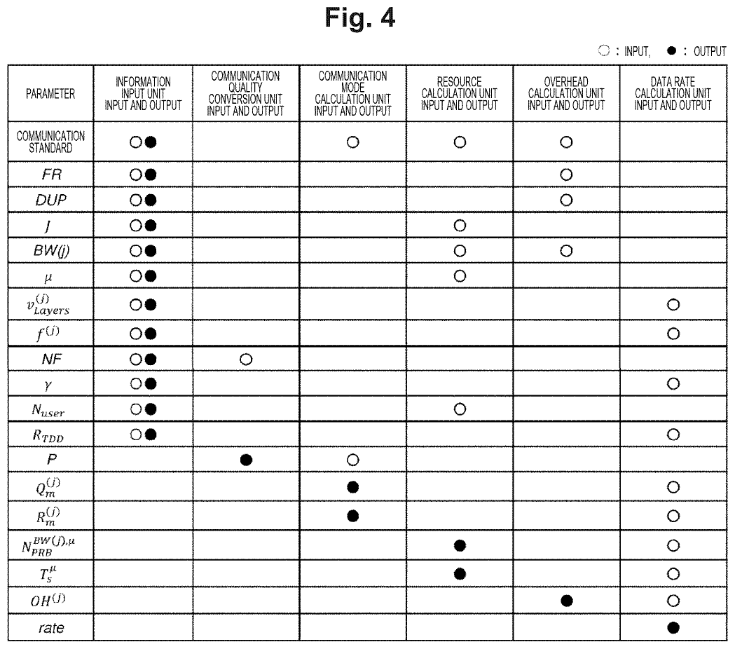

FIG. 4 is a table illustrating an input/output relationship of a parameter used to calculate the user data rate in the user data rate estimation device 100. The input/output relationship illustrated in FIG. 4 is calculated on the basis of a correspondence table (an output value with respect to an input value) set and stored in advance. In the table, for each of the information input unit 130, the communication quality conversion unit 141, the communication mode calculation unit 142, the overhead calculation unit 143, the resource calculation unit 144, and the data rate calculation unit 145, parameters to be input are marked with white circles, and parameters to be output are marked with black circles.

The user data rate estimation device 100 according to the present embodiment is also applicable to a wireless LAN. In this case, the data rate calculation unit 145 calculates a user data rate by using the following Formula (2), for example. Parameters used to calculate the user data rate in Formula (2) are as defined in the above table. Specifically, N_{SD} is the number of data subcarriers determined from a frequency channel bandwidth, Qₘ is a modulation level, Rₘ is a coding rate, v_{Layers} is the number of spatial streams, OH is an overhead, y is a packet error rate, and Tₛ is a sum of an OFDM symbol length and a guard interval length. In a case where the user data rate estimation device 100 is applied to a wireless LAN, the user data rate calculated by the data rate calculation unit 145 by using Formula (2) is output from the user data rate estimation device 100.

$$[ Math . 2 ]$$

$$rate = \frac{{N}_{SD} * {Q}_{m} * {R}_{m} * {v}_{Layers}}{{T}_{s} {N}_{user}} ( 1 - OH ) ( 1 - γ ) \qquad ( 2 )$$

The data rate calculation unit 145 calculates a data rate over the entire target band (a frequency channel used by a user) as a user data rate. The user data rate is calculated on the basis of a reception power in a target band, and a calculation method according to an acquisition pattern for the reception power in the target band is prepared in the data rate calculation unit 145. As described above, acquiring a reception power includes both measuring the reception power and calculating (estimating) the reception power.

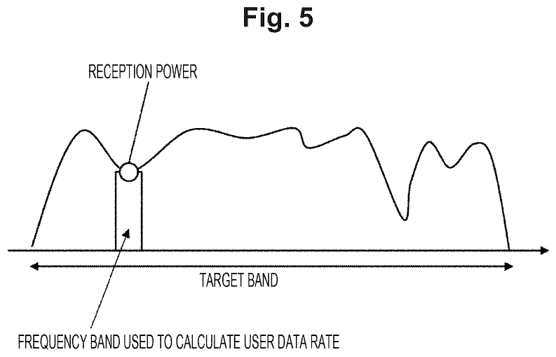

FIG. 5 illustrates a first acquisition pattern for a reception power used to calculate a user data rate. In the first pattern, a reception power is acquired in a part (for example, some OFDM subcarriers) of the target band. In this case, the data rate calculation unit 145 regards the acquired reception power as a representative reception power in the entire band, and calculates the user data rate assuming that the representative reception power can be obtained in the entire target band. Note that, in a case where one reception power is acquired over the entire target band, the user data rate is calculated by using the reception power as the representative reception power.

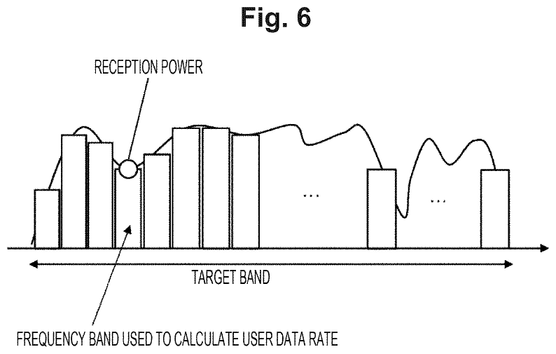

FIG. 6 illustrates a second acquisition pattern for a reception power used to calculate a user data rate. In the second pattern, a reception power in each unit band (for example, a bundle of any OFDM sub-subcarriers) is acquired over the entire target band. In this case, the data rate calculation unit 145 calculates a data rate for each unit band on the basis of the reception power in each unit band with respect to the entire target band. A total sum of the data rate for each unit band in the entire target band is calculated as a user data rate.

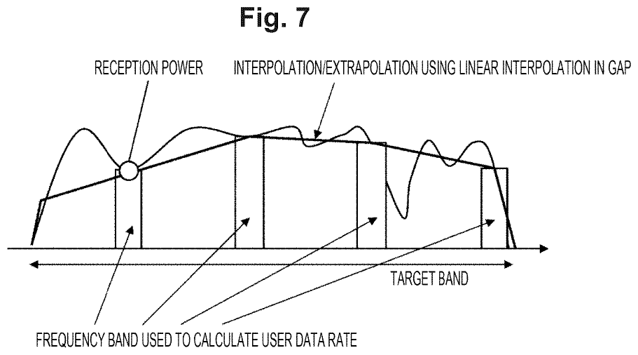

FIG. 7 illustrates a third acquisition pattern for a reception power used to calculate a user data rate. In the third pattern, reception powers in a plurality of unit bands (for example, a bundle of any OFDM sub-subcarriers) discretely selected from the target band are acquired as reference reception powers. For the target band other than the bands in which the reference reception powers have been acquired, a reception power in each unit band is acquired as an interpolation reception power through linear interpolation (interpolation or extrapolation) based on the reference reception powers. In this case, the data rate calculation unit 145 calculates a data rate for each unit band on the basis of the reference reception powers and the interpolation reception powers for the entire target band. A total sum of the data rate for each unit band in the entire target band is calculated as a user data rate.

As is clear from the above description, the user data rate estimation device according to the present embodiment can easily estimate a user data rate according to a communication environment of a user.

### 2. Second Embodiment

### 2-1. Configuration of User Data Rate Estimation Device

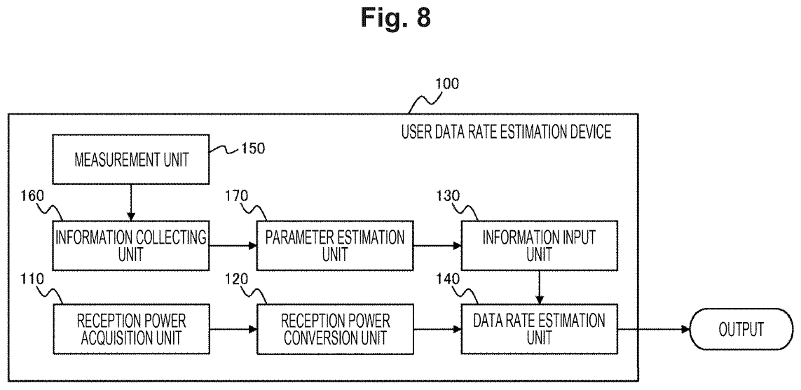

FIG. 8 illustrates a configuration of a user data rate estimation device according to the second embodiment. In the second embodiment, the user data rate estimation device 100 includes a reception power acquisition unit 110, a reception power conversion unit 120, an information input unit 130, a data rate estimation unit 140, a measurement unit 150, an information collecting unit 160, and a parameter estimation unit 170. Hereinafter, functions of the units 110 to 170 configuring the user data rate estimation device 100 will be described. However, description of functions common to those in the first embodiment will be omitted or simplified.

In the second embodiment, the user data rate estimation device 100 has a function of estimating and overwriting some parameters to be input to the information input unit 130. This function is performed by the measurement unit 150, the information collecting unit 160, and the parameter estimation unit 170. The functions of the reception power acquisition unit 110, the reception power conversion unit 120, and the data rate estimation unit 140 are the same as those in the first embodiment. Therefore, description of these functions will be omitted.

The measurement unit 150 is configured to collect information regarding a communication environment from a wireless communication system operating in an area of a user. The measurement unit 150 may be provided in the same hardware as other functions such as the data rate estimation unit 140 as illustrated in FIG. 8, or the measurement unit 150 may be provided in hardware different from the other functions. Here, hardware including the measurement unit 150 will be referred to as a measurement terminal. At least one measurement terminal is installed in an area where measurement is desired to be performed. The measurement unit 150 acquires parameters of a wireless communication system operating in the area where the measurement terminal is installed, and transmits the parameters to the information collecting unit 160. A line used for transmission from the measurement terminal to the information collecting unit 160 may be a wired connection or a wireless connection.

The information collecting unit 160 is configured to collect and record information measured by the measurement unit 150. The information collected by the information collecting unit 160 is stored in association with a position where the measurement unit 150 has performed the measurement.

The parameter estimation unit 170 is configured to calculate an input parameter with higher accuracy by using the information stored in the information collecting unit 160. The input parameter calculated by the parameter estimation unit 170 will be referred to as a parameter estimation value. The parameter estimation unit 170 inputs the calculated parameter estimation value to the information input unit 130 and updates an input parameter of the information input unit 130. The measurement unit 150 or the information collecting unit 160 may check a manufacturing vendor from a MAC address of a terminal or a base station used at the time of measurement, and store an information regarding the manufacturing vendor and a parameter update value in the parameter estimation unit 170.

The information input unit 130 is configured to receive input of information other than the reception power necessary to calculate the data rate. In a case where the parameter estimation value is input from the parameter estimation unit 170 to the information input unit 130, the information input unit 130 overwrites the parameter corresponding to the input information from the parameter estimation unit 170. An input of manufacturing vendor information to the information input unit 130 may be received, a parameter estimation value corresponding to the input manufacturing vendor information may be read from the parameter estimation unit 170, and the read parameter estimation value may be automatically set as a parameter of the information input unit 130.

### 2-2. Example of Process Using Parameter Estimation Value

The parameter estimation unit 170 overwrites a parameter by inputting a parameter estimation value to the information input unit 130. Depending on the type of parameter, the parameter estimation value is used to correct the data rate estimation value estimated by the data rate estimation unit 140. Parameters estimated by the parameter estimation unit 170 are, for example, the number of frequency channels, a frequency channel bandwidth, the number of spatial streams, a block error rate, a modulation level, a coding rate, a reception power, a throughput, an air time rate, and the number of times of retransmission.

Regarding the “number of frequency channels”, in a case where there is a difference between information included in the information collecting unit 160 and a setting value of the information input unit 130, the parameter estimation unit 170 overwrites the setting value of the information input unit 130 by using the information included in the information collecting unit 160. In a case where the information included in the information collecting unit 160 varies with time, the parameter estimation unit 170 calculates an average value of values collected in a certain period (rounding up or rounding down decimal places). In a case where there is a difference between the calculated value and the setting value of the information input unit 130, the parameter estimation unit 170 overwrites the setting value of the information input unit 130 by using the calculated value. A similar process is performed on the “number of spatial streams”.

For the “frequency channel bandwidth”, in a case where there is a difference between the information included in the information collecting unit 160 and the setting value of the information input unit 130, the parameter estimation unit 170 overwrites the setting value of the information input unit 130 by using the information included in the information collecting unit 160.

For the “block error rate”, the parameter estimation unit 170 calculates an average value of values collected in a certain period by the information collecting unit 160. In a case where there is a difference between the calculated average value and the setting value of the information input unit 130, the parameter estimation unit 170 overwrites the setting value of the information input unit 130 by using the calculated average value.

For the “modulation level”, the “coding rate”, and the “reception power”, the parameter estimation unit 170 updates a correspondence table between a communication mode used in the communication mode calculation unit 142 and a reception power. Specifically, an average value of a “reception power” corresponding to the collected “modulation level” and “coding rate” and a corresponding “reception power” in the correspondence table is calculated, and the value in the correspondence table is updated by using the average value. In a case where an SNR is used in the correspondence table instead of a reception power, a value of the collected SNR is used. In a case where an SNR cannot be collected, the parameter estimation unit 170 performs a process similar to that of the communication quality conversion unit 141 by using the collected value of the reception power. A parameter update process is performed by using an SNR converted from the reception power.

For the “throughput”, the parameter estimation unit 170 calculates a difference between a throughput collected by the information collecting unit 160 and a data rate estimation value estimated by the data rate estimation unit 140. At the time of estimation of the next data rate, a corrected data rate estimation value is obtained by adding a difference calculated this time to the data rate estimation value. In a case where there is information regarding differences calculated in the past, an average value of the differences may be calculated by using the information, and correction may be performed by using the average value of the differences. Instead of adding the difference, an error rate (error rate=collected throughput/data rate estimation value) may be calculated and multiplied.

The “air time rate” is defined as a time rate at which other wireless communication devices are not transmitting radio waves in a certain frequency channel. The parameter estimation unit 170 corrects the data rate estimation value estimated by the data rate estimation unit 140 by using the air time rate collected by the information collecting unit 160. Specifically, a corrected data rate estimation value is obtained by multiplying the data rate estimation value by the air time rate.

For the “number of times of retransmission”, the parameter estimation unit 170 calculates an average value of values collected in a certain period by the information collecting unit 160. The data rate estimation value estimated by the data rate estimation unit 140 is corrected by using the calculated average number of times of retransmission. Specifically, a corrected data rate estimation value is obtained by dividing the data rate estimation value by “1+average number of times of retransmission”.

The parameter estimation unit 170 is configured to execute any one of the above-described processes or a plurality of processes including all of the processes in combination. According to the second embodiment, a parameter used to calculate a user data rate is tuned by using information collected in a communication environment in which a user is located, and thus the estimation accuracy of the user data rate can be further enhanced.

### 3. Hardware Configuration of User Data Rate Estimation Device

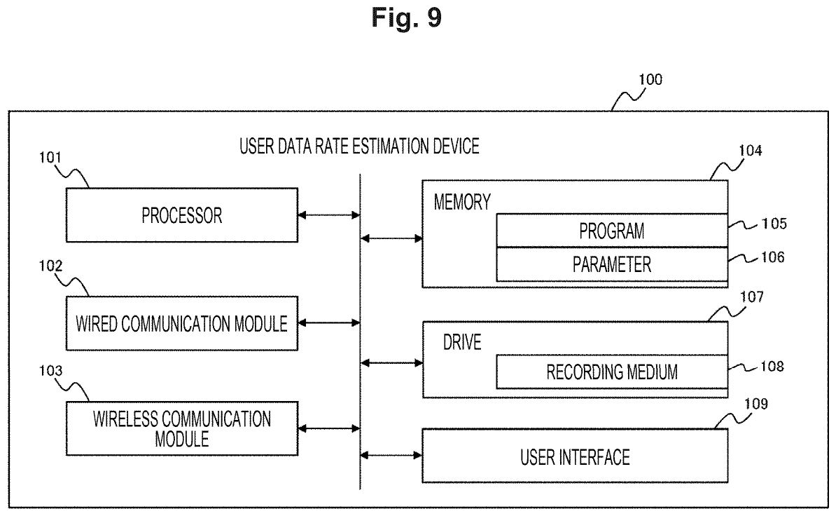

Finally, an example of a hardware configuration of the user data rate estimation device 100 according to the above embodiment will be described with reference to FIG. 9. In the example illustrated in FIG. 9, the user data rate estimation device 100 includes a processor 101, a wired communication module 102, a wireless communication module 103, a memory 104, a drive 107, and a user interface 109. These constituents configuring the user data rate estimation device 100 are connected to each other in a wired manner. The wired communication module 102 is provided for wired communication with an external device. The wireless communication module 103 is provided for wireless communication with an external device. The user interface 109 is provided for an executor of the estimation process to input information.

The memory 104 stores a program 105 and parameters 106. The program 105 is a computer-executable program for performing a user data rate estimation method according to the embodiment of the present disclosure. The parameters 106 are parameters used when the processor 101 executes the program 105, and includes the parameters listed in the above table. The drive 107 includes a storage medium 108. The storage medium 108 stores various types of information including information regarding a communication environment of a user. The storage medium 108 is also used to store the program 105. Note that the program 105 may be provided via a network.

### REFERENCE SIGNS LIST

100 User data rate estimation device
110 Reception power acquisition unit
120 Reception power conversion unit
130 Information input unit
140 Data rate estimation unit
150 Measurement unit
160 Information collecting unit
170 Parameter estimation unit

1. A user data rate estimation device, comprising:
circuitry configured to execute:
acquiring a reception power in a user;
receiving input of information regarding a communication environment of the user;
calculating a wireless resource to be allocated to the user on the basis of information regarding a bandwidth, a scheduling method, and the number of users included in the information regarding the communication environment;
calculating an overhead on the basis of information regarding a communication standard, a frequency band, and a bandwidth included in the information regarding the communication environment;
determining a communication mode on the basis of the reception power or communication quality information converted from the reception power; and
calculating a user data rate on the basis of the wireless resource, the overhead, the communication mode, and information regarding the number of spatial streams included in the information regarding the communication environment.

2. The user data rate estimation device according to claim 1, wherein the circuitry is further configured to execute:
collecting information regarding the communication environment from a wireless communication system operating in an area of the user.

3. The user data rate estimation device according to claim 1, wherein:
the calculating the user data rate further includes calculating the user data rate on the basis of information regarding an uplink/downlink ratio included in the information regarding the communication environment.

4. The user data rate estimation device according to claim 1, wherein;
the acquiring the reception power includes acquiring a reception power in a partial band of a frequency channel used by the user, and
the calculating the user data rate includes calculating the user data rate by using the reception power in the partial band as a representative reception power in an entire band of the frequency channel.

5. The user data rate estimation device according to claim 1, wherein;
the acquiring the reception power includes acquiring a reception power in each unit band over an entire band of a frequency channel used by the user, and
the calculating the user data rate includes
calculating a data rate for each unit band on the basis of the reception power in each unit band for the entire band of the frequency channel, and
calculating, as the user data rate, a sum of the data rate for each unit band with respect to the entire band of the frequency channel.

6. The user data rate estimation device according to claim 1, wherein:
the acquiring the reception power includes
acquiring reception powers in a plurality of unit bands discretely selected in a frequency channel used by the user as reference reception powers, and
acquiring a reception power in each unit band as an interpolation reception power through linear interpolation based on the reference reception powers with respect to a band other than the bands in which the reference reception powers are acquired, and
the calculating the user data rate includes
calculating a data rate for each unit band on the basis of the reference reception powers and the interpolation reception power with respect to an entire band of the frequency channel, and
calculating, as the user data rate, a sum of the data rate for each unit band with respect to the entire band of the frequency channel.

7. A user data rate estimation method, comprising:
acquiring a reception power in a user;
receiving input of information regarding a communication environment of the user;
calculating a wireless resource to be allocated to the user on the basis of information regarding a bandwidth, a scheduling method, and the number of users included in the information regarding the communication environment;
calculating an overhead on the basis of information regarding a communication standard, a frequency band, and a bandwidth included in the information regarding the communication environment;
determining a communication mode on the basis of the reception power or communication quality information converted from the reception power; and
calculating a user data rate on the basis of the wireless resource, the overhead, the communication mode, and information regarding the number of spatial streams included in the information regarding the communication environment.

8. A non-transitory computer-readable storage medium storing a program for causing a computer to execute the user data rate estimation method according to claim 7.
